(19) United States
(12) Patent Application Publication
(10) Pub. No.: US 2020/0364413 A1
(43) Pub. Date: Nov. 19, 2020

(54) ELECTRONIC DEVICE AND CONTROL METHOD THEREOF

(71) Applicant: SAMSUNG ELECTRONICS CO., LTD., Suwon-si, Gyeonggi-do (KR)

(72) Inventor: Yoon-jin YOON, Seoul (KR)

(21) Appl. No.: 16/640,183

(22) PCT Filed: Sep. 11, 2018
(86) PCT No.: PCT/KR2018/010641

§ 371 Date: Feb. 19, 2020

(30) Foreign Application Priority Data
Sep. 20, 2017 (KR) 10-2017-0120934

(51) Int. Cl. G06F 40/58; G06F 40/242; G06F 40/51; G06F 3/0486; G10L 15/00; G10L 15/26

(52) U.S. Cl. CPC G06F 40/58; G06F 40/242; G10L 15/26; G06F 3/0486; G10L 15/005; G06F 40/51

(57) ABSTRACT

An electronic device and a control method thereof are disclosed. The electronic device according to the present disclosure comprises: an input unit; a display; and a processor which controls the display such that, based on a text being inputted through the input unit, a first translation obtained by translating the input text is acquired and the input text and the first translation are displayed, and controls the display such that, based on a predetermined user command being input, at least one related text, related to the input text, and second translations, obtained by translating the at least one related text, is acquired and the input text, the first translation, the at least one related text, and the at least one second translations is displayed.

### TECHNICAL FIELD

The disclosure relates to an electronic device and a control method thereof, and more particularly, to an electronic device capable of providing related text with respect to input text and further providing translations of the input text and related text, and a control method thereof.

### BACKGROUND ART

As technology advances, many people may easily use language translation programs. Such language translation programs may be combined with artificial intelligence systems to provide more accurate translations. The artificial intelligence system is a system in which a machine performs learning and determination by oneself and becomes smart, unlike an existing rule-based smart system. As the artificial intelligence system is more used, a recognition rate is improved and a user's taste may be more accurately understood, and as a result, the existing rule-based smart system has been gradually replaced by a deep learning-based artificial intelligence system.

An artificial intelligence technology includes machine learning (for example, deep learning) and element technologies using the machine learning.

The machine learning is an algorithm technology of classifying and learning features of input data by oneself, and the element technology is a technology that mimics functions of a human brain such as recognition, determination, and the like using a machine learning algorithm such as deep learning, or the like, and includes technical fields such as linguistic understanding, visual understanding, inference/prediction, knowledge representation, a motion control, and the like.

Various fields to which the artificial intelligence technology is applied are as follows. The linguistic understanding is a technology of recognizing and applying/processing human languages/characters, and includes natural language processing, machine translation, a dialog system, question and answer, speech recognition/synthesis, and the like. The visual understanding is a technology of recognizing and processing things like human vision, and includes object recognition, object tracking, image search, human recognition, scene understanding, space understanding, image improvement, and the like. The inference/prediction is a technology of determining and logically inferring and predicting information, and includes knowledge/probability-based inference, optimization prediction, preference-based planning, recommendation, and the like. The knowledge representation is a technology of automating and processing human experience information as knowledge data, and includes knowledge establishment (data generation/classification), knowledge management (data utilization), and the like. The motion control is a technology of controlling autonomous driving of a vehicle, a motion of a robot, and the like, and includes a motion control (navigation, collision, driving), an operation control (behavior control), and the like.

The above-described artificial intelligence technique may also be used for a translation program for translating sentences. The combination of the translation program and the artificial intelligence technology allows the user to be provided with more accurate and contextual translations.

However, the conventional translation program is focused on how accurately an input language may be translated, but there is a problem in that it does not provide other sentences having a context similar to the input sentence.

### DISCLOSURE

### Technical Problem

The disclosure provides an electronic device capable of providing a recommendation sentence having a high correlation with an input sentence and further providing translations of the input sentence and the recommendation sentence, and a control method thereof.

### Technical Solution

According to an embodiment of the disclosure, an electronic device includes: an inputter; a display; and a processor configured to: acquire a first translation in which an input text is translated based on a text being inputted through the inputter, and control the display to display the input text and the first translation, acquire at least one related text related to the input text and second translations in which at least one related text is translated, based on a predetermined user command being inputted, and control the display to display the input text, the first translation, at least one related text, and at least one second translation.

The processor may be configured to control the display to: display the input text and the first translation on a first user interface (UI), and display at least one related text and at least one second translation on a second UI displayed separately from the first UI.

The processor may be configured to control the display to add and display a selected text and a translation corresponding to the selected text to the first UI, based on a user command of selecting one of at least one related text displayed on the second UI being inputted.

At least one related text may be one of an answer text for the input text, a text that is contextually connected to the input text, or a text that supplements the input text.

The electronic device may further include a memory, wherein the processor is configured to: generate a matching table by matching the input text with a selected text based on one of at least one related text being selected, and store the matching table in the memory.

The processor may be configured to control the display to align and display at least one text related to the input text based on the input text and the matching table, in response to the text being inputted through the inputter.

The predetermined user command may be a drag command that touches and drags one of an area on which the input text is displayed or an area on which the first translation is displayed, and the processor may be configured to: acquire at least one related text and at least one second translation that is acquired based on the text, in response to the drag command being inputted to the area on which the text is displayed, and acquire at least one related text and at least one second translation that is acquired based on the first translation, in response to the drag command being inputted to the area on which the first translation is displayed.

The inputter may include a microphone, and the processor may be configured to: acquire a text corresponding to an input voice, based on voice recognition being inputted through the microphone, and acquire an alternative text based on the acquired text, in response to the acquired text being an incomplete sentence.

According to another embodiment of the disclosure, a control method of an electronic device includes: acquiring a first translation in which an input text is translated based on a text being inputted, and displaying the input text and the first translation; acquiring at least one related text related to the input text and second translations in which at least one related text is translated, based on a predetermined user command being inputted; and displaying the input text, the first translation, at least one related text, and at least one second translation.

In the displaying, the input text and the first translation may be displayed on a first user interface (UI), and at least one related text and at least one second translation may be displayed on a second UI displayed separately from the first UI.

The displaying may further include adding and displaying a selected text and a translation corresponding to the selected text to the first UI, based on a user command of selecting one of at least one related texts displayed on the second UI being inputted.

At least one related text may be one of an answer text for the input text, a text that is contextually connected to the input text, or a text that supplements the input text.

The control method may further include generating a matching table by matching the input text with a selected text based on one text of at least one related text being selected, and storing the matching table.

The displaying may further include aligning and displaying at least one texts related to the input text based on the input text and the matching table, in response to the text being inputted.

The predetermined user command may be a drag command that touches and drags one of an area on which the input text is displayed or an area on which the first translation is displayed, and in the acquiring of the second translations, at least one related text and at least one second translation that is acquired based on the text may be acquired, in response to the drag command being inputted to the area on which the text is displayed, and at least one related text and at least one second translation that is acquired based on the first translation may be acquired, in response to the drag command being inputted to the area on which the first translation is displayed.

The control method may further include receiving a voice of a user and acquiring a text corresponding to the received voice, and acquiring an alternative text based on the acquired text, in response to the acquired text being an incomplete sentence.

According to another embodiment of the disclosure, a computer readable recording medium including a program for controlling an electronic device is provided, in which the control method of the electronic device includes: acquiring a first translation in which an input text is translated based on a text being inputted, and displaying the input text and the first translation; acquiring at least one related text related to the input text and second translations in which at least one related text is translated, based on a predetermined user command being inputted; and displaying the input text, the first translation, at least one related text, and at least one second translation.

### Advantageous Effects

As described above, according to diverse embodiment of the disclosure, the electronic device may display the related texts for the input text.

### DESCRIPTION OF DRAWINGS

FIG. 1 illustrates a screen of an electronic device for extension translation according to an embodiment of the disclosure.

FIG. 2 is a block diagram schematically illustrating components of an electronic device 100 according to an embodiment of the disclosure.

FIG. 3 is a detailed block diagram illustrating the components of the electronic device 100 according to an embodiment of the disclosure in detail.

FIGS. 4A to 4C are illustrative diagrams for describing a first UI according to an embodiment of the disclosure.

FIGS. 5A to 5C are illustrative diagrams for describing a second UI according to an embodiment of the disclosure.

FIG. 6 is an illustrative diagram for describing a case of adding related texts to a first UI 610 according to an embodiment of the disclosure.

FIG. 7 is an illustrative diagram for describing a method of executing an extension translation based on a translation.

FIG. 8 is an illustrative diagram for describing a method of executing the extension translation in a second UI.

FIG. 9 is an illustrative diagram for describing a method of receiving text through voice recognition according to another embodiment of the disclosure.

FIGS. 10A and 10B are illustrative diagrams for describing a method of aligning related texts according to an embodiment of the disclosure.

FIG. 11 is a flowchart for describing a control method of an electronic device according to an embodiment of the disclosure.

FIG. 12 is an illustrative diagram for describing a system according to an embodiment of the disclosure.

FIGS. 13A and 13B are block diagrams illustrating a learner and a recognizer according to diverse embodiments of the disclosure.

FIG. 14 is a diagram illustrating an example in which an electronic device 100 and a server 200 interlock with each other to learn and recognize data according to an embodiment of the disclosure.

FIG. 15 is a flowchart of an electronic device using a recognition model according to an embodiment of the disclosure.

FIG. 16 is a flowchart of a network system using a recognition model according to an embodiment of the disclosure.

FIG. 17 is a flowchart of an electronic device using a recognition model according to another embodiment of the disclosure.

FIG. 18 is a flowchart of a network system using a recognition model according to an embodiment of the disclosure.

### BEST MODE

Hereinafter, diverse embodiments of the disclosure will be described with reference to the accompanying drawings. However, it is to be understood that technologies mentioned in the disclosure are not limited to specific embodiments, but include all modifications, equivalents, and/or substitutions according to embodiments of the disclosure. Throughout the accompanying drawings, similar components will be denoted by similar reference numerals.

In the disclosure, an expression “have”, “may have”, “include”, “may include”, or the like, indicates an existence of a corresponding feature (for example, a numerical value, a function, an operation, a component such as a part, or the like), and does not exclude an existence of an additional feature.

In the disclosure, an expression “A or B”, “at least one of A and/or B”, “one or more of A and/or B”, or the like, may include all possible combinations of items listed together. For example, “A or B”, “at least one of A and B”, or “at least one of A or B” may indicate all of 1) a case in which at least one A is included, 2) a case in which at least one B is included, or 3) a case in which both of at least one A and at least one B are included.

Expressions “first”, “second”, and the like, used in the disclosure may indicate various components regardless of a sequence and/or importance of the components, will be used only in order to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled with/to another component or may be coupled with/to another component through the other component (for example, a third component). On the other hand, when it is mentioned that any component (for example, a first component) is “directly coupled with/to” or “directly connected to” to another component (for example, a second component), it is to be understood that the other component (for example, a third component) is not present between any component and another component.

An expression “configured (or set) to” used in the disclosure may be replaced by an expression “suitable for”, “having the capacity to”, “designed to”, “adapted to”, “made to”, or “capable of” depending on a situation. A term “configured (or set) to” may not necessarily mean only “specifically designed to” in hardware. Instead, in any context, an expression “a device configured to” may mean that the device is “capable of” together with other devices or components. For example, a “sub-processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

An electronic device according to diverse embodiments of the disclosure may include at least one of, for example, a smartphone, a tablet personal computer (PC), a mobile phone, an image phone, an e-book reader, a desktop personal computer (PC), a laptop personal computer (PC), a netbook computer, a workstation, a server, a personal digital assistant (PDA), a portable multimedia player (PMP), an MP3 player, a medical device, a camera, or a wearable device. The wearable device may include at least one of an accessory type (for example, a watch, a ring, a bracelet, an ankle bracelet, a necklace, a glasses, a contact lens, or a head-mounted-device (HMD)), a textile or clothing integral type (for example, an electronic clothing), a body attachment type (for example, a skin pad or a tattoo), or a bio-implantable circuit. In some embodiments, the electronic device may include at least one of, for example, a television (TV), a digital video disk (DVD) player, an audio player, a refrigerator, an air conditioner, a cleaner, an oven, a microwave oven, a washing machine, an air cleaner, a set-top box, a home automation control panel, a security control panel, a media box (for example, HomeSync™ of Samsung Electronics Co., Ltd, TV™ of Apple Inc, or TV™ of Google), a game console (for example Xbox™, PlayStation™), an electronic dictionary, an electronic key, a camcorder, or a digital photo frame.

In other embodiments, the electronic device may include at least one of various medical devices (for example, various portable medical measuring devices (such as a blood glucose meter, a heart rate meter, a blood pressure meter, a body temperature meter, or the like), a magnetic resonance angiography (MRA), a magnetic resonance imaging (MRI), a computed tomography (CT), a photographing device, an ultrasonic device, or the like), a navigation device, a global navigation satellite system (GLASS), an event data recorder (EDR), a flight data recorder (FDR), an automobile infotainment device, a marine electronic equipment (for example, a marine navigation device, a gyro compass, or the like), avionics, a security device, an automobile head unit, an industrial or household robot, a drone, an automatic teller's machine (ATM) of a financial institute, a point of sales (POS) of a shop, or Internet of things (IoT) devices (for example, a light bulb, various sensors, a sprinkler system, a fire alarm, a thermostat, a street light, a toaster, an exercise equipment, a hot water tank, a heater, a boiler, and the like).

In the disclosure, a term “user” may be a person that uses the electronic device or a device (e.g., an artificial intelligence electronic device) that uses the electronic device.

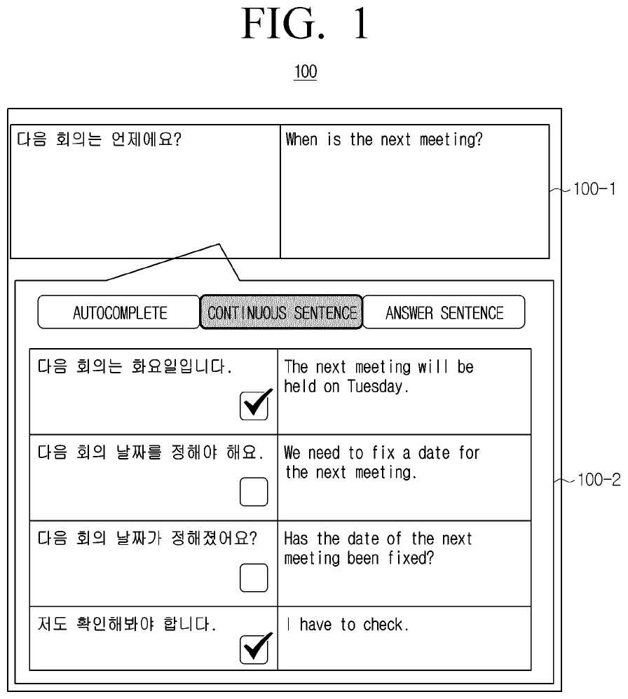

FIG. 1 illustrates a screen of an electronic device 100 for extension translation according to an embodiment of the disclosure.

In this case, the extension translation refers to an operation of acquiring or displaying at least one text related to input text and a translation of at least one text according to a user command.

As illustrated in FIG. 1, a display of an electronic device 100 may include a first UI 100-1 and a second UI 100-2. When a user command for text input is input, the electronic device 100 may display text corresponding to the input user command on the left side of the first UI 100-1. In this case, a translation corresponding to the input text may be displayed on the right side of the first UI 100-2. In this case, the translation may be automatically displayed when the text is input or may also be translated by a user command to translate the text.

In a state in which the text and the translation are displayed on the first UI 100-1, if a predetermined user command is input, the electronic device 100 may display related texts related to the input text on the second UI 100-2. In this case, the predetermined user command may be various kinds of commands. For example, the predetermined user command may be a command for touching and dragging an input text region of the first UI 100-1. Alternatively, the predetermined user command may be a command for double tapping the input text region of the first UI 100-1. Alternatively, the predetermined user command may be a command for clicking or touching an element (not illustrated) displayed on a specific region of the first UI 100-1. In addition to the above-described commands, the predetermined user command may be various kinds of commands. In this case, the user may input the predetermined user command after pressing (or while pressing) a button (e.g., a button for executing an artificial intelligence function) provided in the electronic device 100.

As illustrated in FIG. 1, the second UI 100-2 may include autocomplete, continuous sentence, and answer sentence elements. When a user command for the corresponding element is input, the electronic device 100 may provide related texts corresponding to the corresponding element and translations for the related texts.

Meanwhile, when a user command to select at least one of the related texts displayed on the second UI 100-2 is input, the electronic device 100 may add and display the selected related text and a translation thereof to the first UI 100-1. Details thereof will be described in detail below.

In addition, according to diverse embodiments of the disclosure, the electronic device 100 may acquire general text information (e.g., information of words parsed from the text, context information about the text, etc.) using the input text as input data of a recognition model, and may acquire the related texts by using the acquired text information. In the disclosure, a learned recognition model may be constructed in consideration of an application field of the recognition model, a computer performance of the device, or the like. For example, a learned object recognition model may be set to estimate object information reflecting the context using an object region and surrounding information of the object as input data. The learned object recognition model may be, for example, a model based on a neural network. The object recognition model may be designed to simulate a human brain structure on a computer, and may include a plurality of network nodes having weights that simulate neurons of the neural network of a human. The plurality of network nodes may form a connection relationship so that the neurons simulate synaptic activity of the neurons through which signals are transmitted and received through synapses. In addition, the object recognition model may include, for example, a neural network model or a deep learning model developed from the neural network model. In the deep learning model, the plurality of network nodes may be located at different depths (or layers) and transmit and receive data according to a convolution connection relationship. Examples of the object recognition model may include a deep neural network (DNN), a recurrent neural network (RNN), a bidirectional recurrent deep neural network (BRDNN), and the like, but are not limited thereto.

In addition, the electronic device 100 may use an artificial intelligence agent to acquire the related texts for the text input by the user as described above. In this case, the artificial intelligence agent may be a dedicated program for providing artificial intelligence (AI) based services (e.g., voice recognition service, secretary service, translation service, search service, etc.) and may be executed by an existing general purpose processor (e.g., CPU) or a separate AI dedicated processor (e.g., GPU or the like).

For example, if a text for obtaining the related texts is input after a button provided in the electronic device 100 is pressed to execute the artificial intelligence agent, the artificial intelligence agent may operate. In addition, the artificial intelligence agent may acquire and provide the related texts for the input text.

Of course, the artificial intelligence agent may also operate when a specific icon is touched on the screen. For example, when an extension translation UI for the input text displayed on the screen is touched by the user, the artificial intelligence agent may be automatically executed to acquire the related texts.

Meanwhile, in the above-described embodiment, a feature of executing the artificial intelligence agent when acquiring the related texts for the input text has been described, but the disclosure is not limited thereto. That is, the artificial intelligence agent may be used not only when acquiring the related texts for the input text but also when acquiring the translation for the input text.

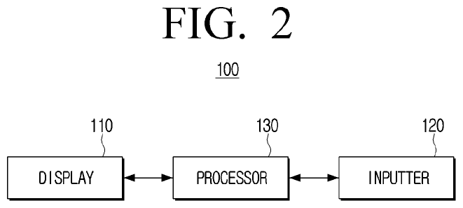

FIG. 2 is a block diagram schematically illustrating components of an electronic device 100 according to an embodiment of the disclosure. As illustrated in FIG. 2, the electronic device 100 includes a display 110, an inputter 120, and a processor 130.

The display 110 may provide various screens. In particular, the display 110 may display a text corresponding to a user command input through the inputter 120, a translation of the input text, at least one text related to the input text, and a translation of at least one text related to the input text.

The inputter 120 may receive various user commands and transmit them to the processor 130. In this case, the inputter may be configured in various forms to receive various user commands. For example, the inputter 120 may include a keyboard or a microphone for receiving the text, and may include a touch panel or a physical button for receiving an extension translation command.

The processor 130 controls an overall operation of the electronic device 100. In particular, when the text is input through the inputter, the processor 130 may acquire a first translation in which the input text is translated. In this case, the processor 130 may control the display 120 to display the input text and a translation thereof.

In addition, when a user command for extension translation is input, the processor 130 may acquire one or more related texts related to the input text and one or more second translations for one or more related texts. In this case, the processor 130 may control the display 120 to display one or more related texts and one or more second translations.

In this case, the processor 130 may control the display 120 to display the input text and the translation thereof on the first UI and to display one or more related texts and one or more second translations on the second UI displayed separately from the first UI.

In this case, when a user command to select at least one of the related texts displayed on the second UI is input, the processor 130 may control the display 120 to add and display the selected related text and a translation thereof to the first UI.

Meanwhile, regarding to the processor 130 as described above, an existing general purpose processor (e.g., a CPU or an application processor) may perform the above-described operations, but for specific operations, a dedicated hardware chip for artificial intelligence (AI) may perform the operations. For example, when the related texts for the input text are acquired, the dedicated hardware chip for artificial intelligence may be used, and the general purpose processor may be used for other operations.

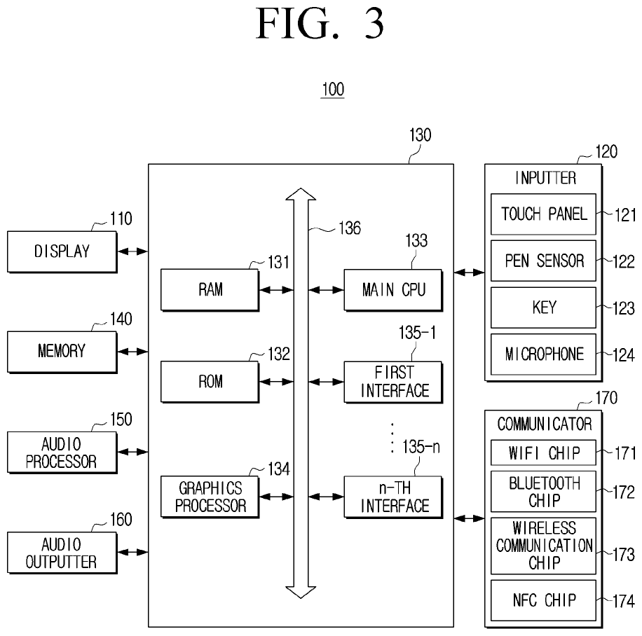

FIG. 3 is a detailed block diagram illustrating the components of the electronic device 100 according to an embodiment of the disclosure in detail. Specifically, the electronic device 100 may further include a memory 140, an audio processor 150, an audio outputter 160, and a communicator 170, in addition to the display 110, the inputter 120, and the processor 130. However, the electronic device 100 is not limited to the above-described configuration, and various configurations may be added to or omitted from the electronic device 100, if necessary.

The display 110 may provide various screens as described above. The display 110 for providing various screens may be implemented as various types of display panels. For example, the display panel may be implemented by various display technologies such as a liquid crystal display (LCD), an organic light emitting diode (OLED), an active-matrix organic light-emitting diode (AM-OLED), a liquid crystal on silicon (LcoS), or a digital light processing (LDP). In addition, the display 110 may also be coupled to at least one of a front region, a side region, and a rear region of the electronic device 100 in the form of a flexible display.

The inputter 120 may include a touch panel 121, a pen sensor 122, a key 123, and a microphone 124 to receive various inputs. The touch panel 121 may be configured by combining the display 110 and a touch sensor (not illustrated) and may use at least one of a capacitive manner, a resistive manner, an infrared manner, or an ultrasonic manner. The pen sensor 122 may be implemented as a portion of the touch panel 121, or may include a separate sheet for recognition. The key 123 may include a physical button, an optical key, or a keypad. The microphone 124 may include at least one of an internal microphone or an external microphone.

In particular, the inputter 120 may receive external commands from the above-described components and transmit them to the processor 130. The processor 130 may generate a control signal corresponding to the received input to control the electronic device 100.

The memory 140 may store an operating system (O/S) for driving the electronic device 100. In addition, the memory 140 may also store various software programs or applications for operating the electronic device 100 according to the diverse embodiments of the disclosure. The memory 140 may store various kinds of information such as various kinds of data which is input, set, or generated during execution of the programs or the applications.

In addition, the memory 140 may include various software modules for operating the electronic device 100 according to the diverse embodiments of the disclosure, and the processor 130 may execute the various software modules stored in the memory 140 to perform an operation of the electronic device 100 according to the diverse embodiments of the disclosure.

In addition, the memory 140 may store an artificial intelligence agent for providing the related texts for the input text, and may also store the recognition mode according to the disclosure.

In particular, the memory 140 may store a matching table generated by matching the input text with a text selected by the user command among one or more related texts. The matching table may be used to align the related texts when a new text is input. To this end, the memory 140 may include a semiconductor memory such as a flash memory or the like, or a magnetic storing medium such as a hard disk or the like. In addition, the memory 140 may store an artificial intelligence agent for providing the related texts for the input text.

Meanwhile, some of the configurations or functions of the memory 140 as described above may be implemented as an external device. For example, the matching table or the artificial intelligence agent may be stored in a memory (not illustrated) of an external server.

The audio processor 150 is a component that performs processing on audio data. The audio processor 150 may perform various processing such as decoding, amplification, noise filtering, and the like on the audio data. The audio data processed by the audio processor 150 may be output to the audio outputter 160.

The audio outputter 160 is a component that outputs various alarms or voice messages as well as various audio data on which various kinds of processing such as decoding, amplification, noise filtering, and the like, are performed by the audio processor 150. In particular, the audio outputter 160 may be implemented as a speaker, but this is only one example, and the audio outputter 160 may be implemented as an output terminal that may output the audio data.

The communicator 170 may perform communication with the external device. In particular, the communicator 170 may include various communication chips such as a wireless fidelity (WiFi) chip 171, a Bluetooth chip 172, a wireless communication chip 173, and a near field communication (NFC) chip 174. In this case, the WiFi chip 171, the Bluetooth chip 172, and the NFC chip 174 perform communication in a LAN scheme, a WiFi scheme, a Bluetooth scheme, an NFC scheme, respectively. In the case of using the WiFi chip 171 or the Bluetooth chip 172, various kinds of connection information such as a service set identifier (SSID), a session key, and the like, are first transmitted and received, communication is connected using the connection information, and various kinds of information may then be transmitted and received. The wireless communication chip 173 means a chip that performs communication depending on various communication protocols such as Institute of Electrical and Electronics Engineers (IEEE), Zigbee, 3^{rd} generation (3G), 3rd generation partnership project (3GPP), long term evolution (LTE), and the like. In particular, the communicator 170 may receive various kinds of information from an external device (e.g., a content server that provides a product image). For example, the communicator 170 may receive various indoor images, product information, and product images from the external device, and store the received information in the memory 140.

The processor 130 controls the overall operation of the electronic device 100, as described above. The processor 130 may include Random Access Memory (RAM) 131, Read Only Memory (ROM) 132, a main central processing unit (CPU) 133, a graphic processor 134, first to n-th interfaces 135-1 to 135-n, and a bus 136. In this case, the RAM 131, the ROM 132, the main CPU 133, the graphic processor 134, the first to n-th interfaces 135-1 to 135-n, and the like, may be connected to each other through the bus 136.

An instruction set for booting a system, or the like is stored in the ROM 132. When a turn-on command is input to supply power, the main CPU 133 may copy an operating system (O/S) stored in the memory 140 to the RAM 131 depending on an instruction stored in the ROM 132, and execute the O/S to boot the system. When the booting is completed, the main CPU 133 copies various application programs stored in the memory 170 to the RAM 131, and executes the application programs copied to the RAM 131 to perform various operations.

The main CPU 133 accesses the memory 140 to perform the booting using the O/S stored in the memory 140. In addition, the main CPU 133 performs various operations using various programs, contents, data, and the like, stored in the memory 140.

The first to n-th interfaces 135-1 to 135-n are connected to the various components described above. One of the interfaces may be a network interface connected to an external device through a network.

As described above, the processor 130 may translate the input text and acquire one or more related texts for the input text. In particular, the processor 130 may control the display 110 to align and display one or more related texts using the matching table stored in the memory 140.

For example, if the input text is included in the matching table stored in the memory 140, the processor 130 may control the display 120 to display and align a text most selected by the user command, among one or more related texts for the input text, on the top of the second UI.

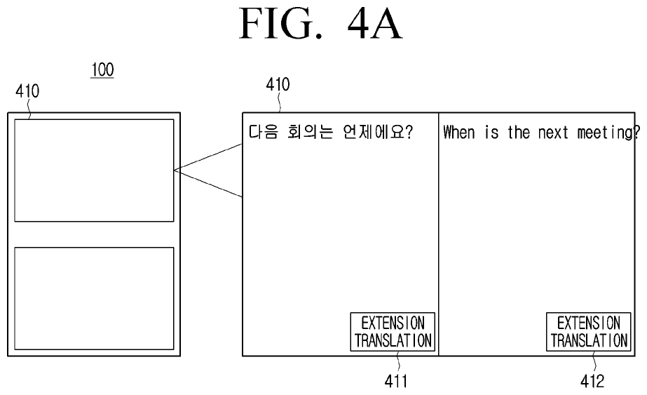

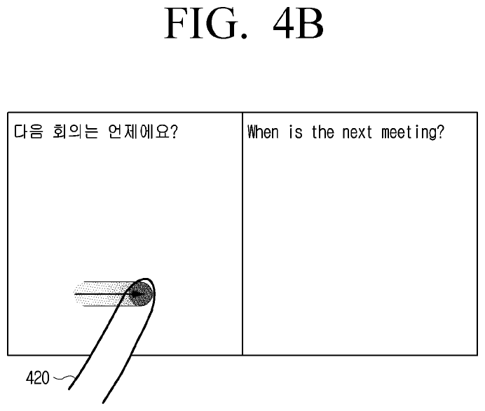

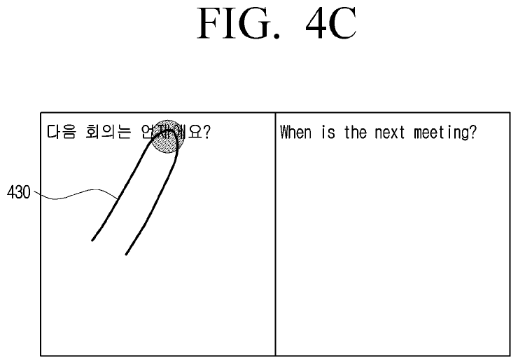

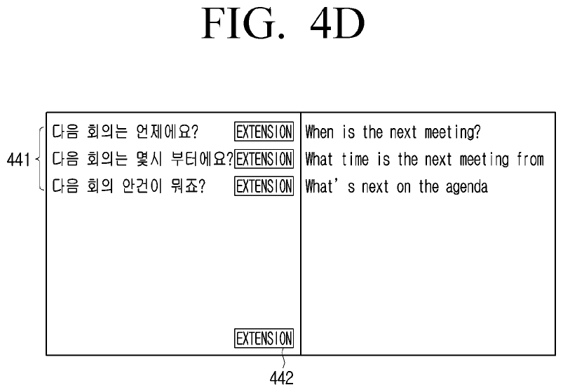

Hereinafter, diverse embodiments of the disclosure will be described with reference to FIGS. 4A to 11.

FIGS. 4A to 4C are illustrative diagrams for describing a first UI according to an embodiment of the disclosure.

As illustrated in FIG. 4A, the electronic device 100 may display a first UI 410. In this case, a text input according to the user command may be displayed on the left side of the first UI 410, and a translation for the text input according to the user command may be displayed on the right side thereof.

For example, When a text “ [symbol] ” is input on the left side of the first UI 410, the electronic device 100 may display “When is the next meeting?” on the right side of the first UI.

In this case, when the text is input, the electronic device 100 may automatically display a translation for the text. However, the disclosure is not limited thereto, and when a user command for translation is input, the electronic device 100 may also acquire and display a translation for the input text. That is, although not illustrated in FIG. 4A, the first UI 410 may include a translation element for receiving a translation command, and when the user command is input through the translation element, the electronic device 100 may translate the input text. In this case, the user command through the translation element may be a user command that touches or clicks the translation element, and may also be a voice command.

Meanwhile, the first UI 410 may include extension translation elements 411 and 412 for extension translation. In this case, when the user command is input through the extension translation element, the electronic device 100 may display one or more related texts for the input text on the second UI displayed separately from the first UI 410.

In this case, the user command for extension translation may be input by various methods. For example, as illustrated in FIG. 4A, when the first UI 410 includes the extension translation elements 411 and 412, the electronic device 100 may receive a user command that touches or clicks the extension translation elements 411 and 412, and may display the second UI according to the input user command. In this case, the displayed second UI may be a UI that displays the related texts for the input text.

Meanwhile, as described above, when the user command that touches the extension translation elements 411 and 412 is input, the electronic device 100 may acquire the related texts for the input text using the artificial intelligence agent.

However, the disclosure is not limited to such an embodiment, but only when a button for executing the artificial intelligence agent is pressed, the electronic device 100 may also acquire the related texts using the artificial intelligence agent. In this case, when a user command that does not press the artificial intelligence agent and touches the extension translation elements 411 and 412 is input, the electronic device 100 may acquire the related texts using a general purpose processor.

As another example, as illustrated in FIG. 4B, when a user command that touches and drags the first UI 410 is input, the electronic device 100 may also display the second UI. Alternatively, as illustrated in FIG. 4C, when a command that directly touches or clicks the input text is input, the electronic device 100 may also display the second UI. However, the second UI may be displayed by various methods in addition to the above-described embodiments. In addition, even when the related texts are acquired as illustrated in FIGS. 4B and 4C, the electronic device 100 may acquire the related texts using the artificial intelligence agent according to the above-described method.

Meanwhile, the text that is input to the first UI 410 may be one sentence (“ [symbol] ?”) as illustrated in FIGS. 4A to 4C, but is not limited thereto. That is, the text that is input to the first UI 410 may also be a word, phrase, sentence, or paragraph.

In this case, as illustrated in FIG. 4D, when the text displayed on the first UI 410 is a plurality of sentences, the electronic device 100 may display an extension translation element 441 for each of the plurality of sentences. That is, the amount of calculation required for the electronic device 100 to find related texts for all the plurality of sentences may be excessively larger than the amount of calculation required for the electronic device 100 to find the related texts for one sentence. Therefore, when the plurality of sentences are included in the first UI 410, the electronic device 100 may display the extension search element 441 for acquiring the related texts for each sentence. However, even in this case, the electronic device 100 may display the extension search element 442 for the entire text including the plurality of sentences.

Meanwhile, in the embodiment described with reference to FIG. 4D, it has been described that the extension translation element 441 for one sentence is displayed, but the disclosure is not limited thereto. That is, the electronic device 100 may display an extension translation element for one paragraph. For example, when the text is input and an enter key of a keyboard (or a user command corresponding to the enter key of the keyboard) is input, the electronic device may display the extension translation element while changing a line where the text is input.

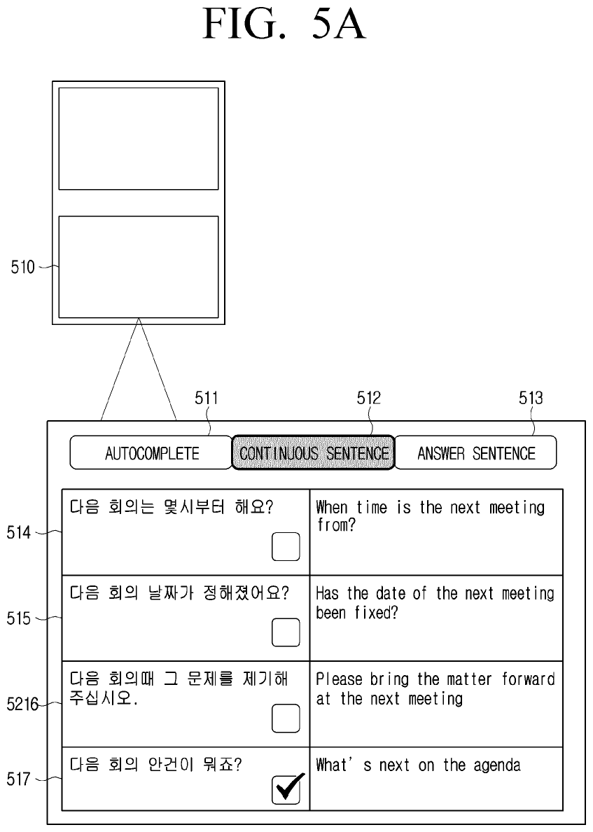

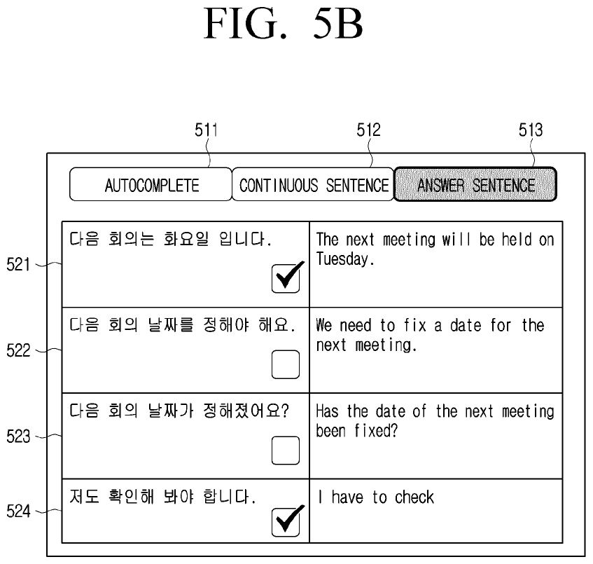

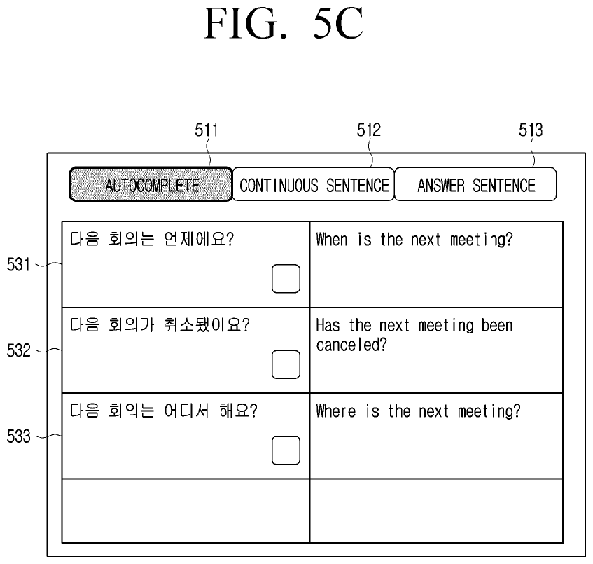

FIGS. 5A to 5C are illustrative diagrams for describing a second UI according to an embodiment of the disclosure.

As described with reference to FIGS. 4A to 4C, when the user command for extension translation is input, the electronic device 100 may display the related texts for the input text and the translations thereof on the second UI 510. Although FIG. 5A illustrates that the first UI and the second UI 510 are always displayed on the electronic device 100, the disclosure is not limited thereto. That is, the second UI 510 may not be initially displayed on the display 110 of the electronic device 100, and may be displayed when the user command for extension translation is input. However, the disclosure will be described based on the case where the electronic device 100 always displays the first UI and the second UI 510 for convenience of explanation.

The second UI 510 may include an autocomplete element 511, a continuous sentence element 512, and an answer sentence element 513. The electronic device 100 may display the related texts for any one of the three elements 511 to 513 displayed on the second UI 510 and a translations thereof on the second UI 510.

In particular, FIG. 5A is an illustrative diagram for describing a case in which the continuous sentence element 512 is selected from the three elements 511 to 513. In this case, the continuous sentence refers to a sentence that may follow the text input to the first UI. Specifically, as illustrated in FIG. 5A, when a text “ [symbol] ?” is input, the electronic device 100 may display continuous sentences such as “ [symbol] [symbol] ?”, “ [symbol] [symbol] ?”, “ [symbol] [symbol] [symbol] ?”, and “ [symbol] [symbol] ?” on the second UI 510.

In this case, selection elements 514 to 517 capable of selecting a corresponding sentence may be displayed on the right side of each consecutive sentence. When a user command for the selection element is input, the electronic device 100 may add the selected text to the first UI. A detailed description thereof will be provided below.

FIG. 5B is an illustrative diagram for describing an embodiment in which the answer sentence element 513 is selected. Specifically, as illustrated in FIG. 5B, when a text “ [symbol] [symbol] ?” is input to the first UI, the electronic device 100 may display answer sentences such as “ [symbol] [symbol] .”, “ [symbol] [symbol] ”, “ [symbol] [symbol] ?”, and “ [symbol] [symbol] ” on the second UI 510. In this case, selection elements 521 to 524 capable of selecting a corresponding sentence may be displayed on the right side of each answer sentence, and a description thereof is the same as that described in FIG. 5A.

Meanwhile, FIG. 5C is an illustrative diagram for describing an embodiment in which the autocomplete element 511 is selected. For example, when the text input to the first UI is “ [symbol] (tomorrow meeting)”, the electronic device 100 may determine that “ [symbol] ” is an incomplete sentence, and may recommend a completed sentence such as “ [symbol] [symbol] ?”, “ [symbol] [symbol] ?”, or “ [symbol] [symbol] ?”.

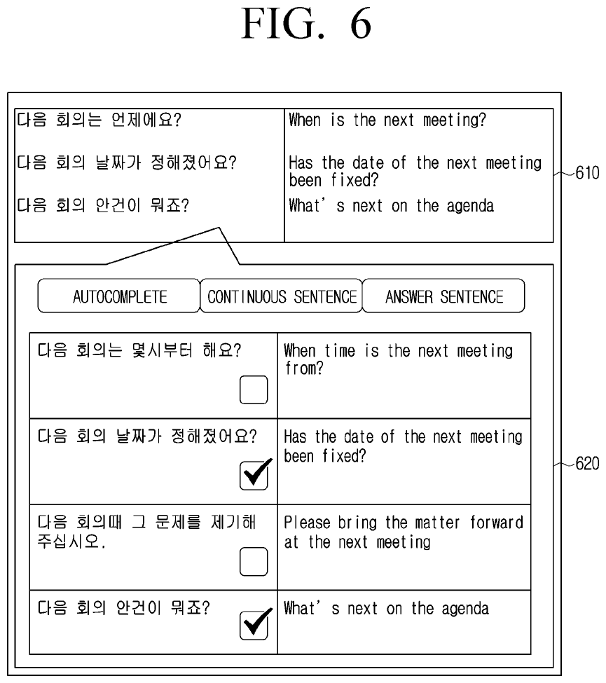

FIG. 6 is an illustrative diagram for describing a case of adding related texts to a first UI according to an embodiment of the disclosure. Specifically, as illustrated in FIG. 4A, “ [symbol] [symbol] ?” may be input on the left side of the first UI 610, and as an extension translation result thereof, at least one text as illustrated in FIG. 5A may be displayed.

In this case, when the electronic device 100 receives a command for selecting at least one of one or more related texts displayed on the second UI 620, the electronic device 100 may add and display one or more selected related texts and one or more second translations in which one or more related texts are translated to the first UI 610.

For example, as illustrated in FIG. 6, when “ [symbol] [symbol] ?” 612 and “ [symbol] [symbol] ?” 614 are selected from one or more related texts 611 to 614 displayed on the second UI 620, the electronic device 100 may add and display the selected text to the first UI 610. That is, the electronic device 100 may add and display “ [symbol] [symbol] ?” 612 and “ [symbol] [symbol] ?”614 in a state in which “ [symbol] [symbol] ?”, which is the text input to the first UI 610, is not deleted.

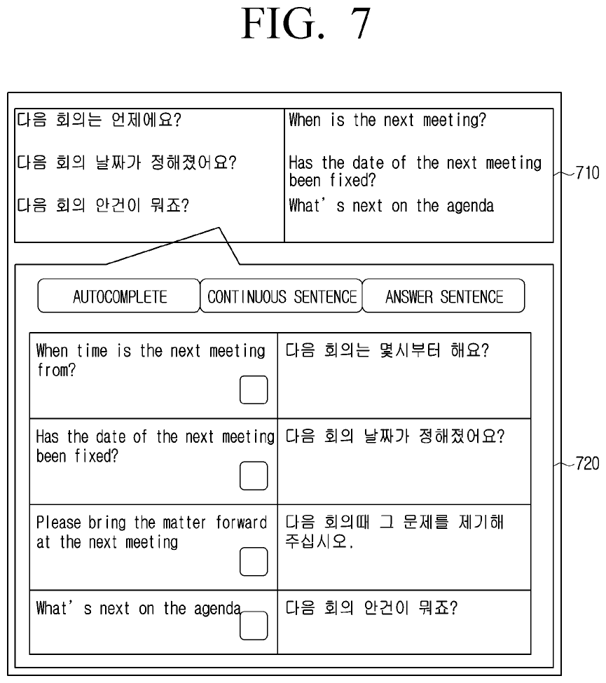

FIG. 7 is an illustrative diagram for describing a method of executing an extension translation based on a translation.

Although FIGS. 4A to 6 describe the method of displaying the extension translation result for the input text on the second UI, the disclosure is not limited thereto. For example, as illustrated in FIG. 4A, when a user command that touches the extension translation element 412 displayed on the right side of the first UI 410 is input, the electronic device 100 may perform an extension translation for a language of the translated text.

Specifically, as illustrated in FIG. 7, when an extension translation for “When is the next meeting” displayed on a first UI 710 is performed, the electronic device 100 may display related texts for “When is the next meeting” on the left side of a second UI 720.

On the other hand, the above description is based on the example that the extension translation is executed when the user command is input through the extension translation element 412, but the extension translation is not limited thereto. That is, as described above, the extension translation may be performed through various methods such as user gesture, motion, touch input, voice recognition, and the like.

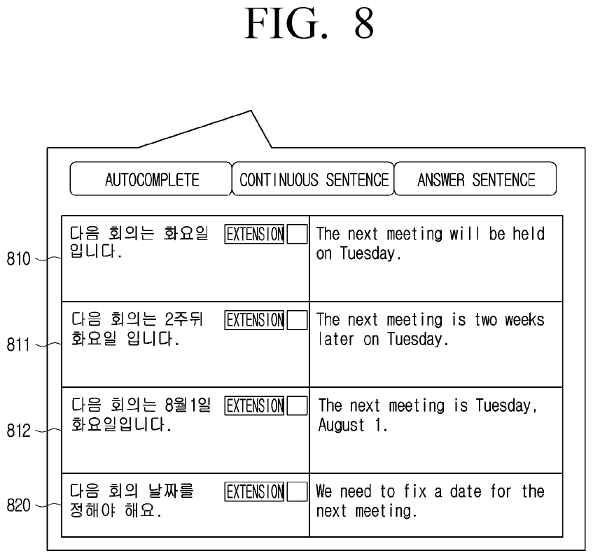

FIG. 8 is an illustrative diagram for describing a method of executing the extension translation in a second UI. Specifically, as illustrated in FIG. 8, the electronic device 100 may perform an extension translation for one or more related texts displayed on a second UI.

For example, when a sentence 1 810 and a sentence 2 820 are displayed on the second UI, the electronic device 100 may perform the extension translation for the sentence 1 810 on the second UI.

That is, when a user command for an extension translation element existing on the right side of sentence 1 810 is input, the electronic device 100 may acquire and display one or more related texts for the sentence 1 810. Specifically, as illustrated in FIG. 8, the related texts for the sentence 1 810 may be a sentence 1-1 811 and a sentence 1-2 812.

In this case, as illustrated in FIG. 8, the sentence 1 may be “ [symbol] [symbol] .”, the sentence 2 may be “ [symbol] [symbol] .”, the sentence 1-1 may be “ [symbol] 2 [symbol] .”, and the sentence 1-2 may be [symbol] 8 [symbol] 1 [symbol] .”

In this case, the electronic device 100 may hierarchically display the sentence 1 810, the sentence 1-1 811, and the sentence 1-2 812. That is, as illustrated in FIG. 8, the sentence 1-1 811 and the sentence 1-2 812 may be displayed to start from the right side than the sentence 810. Accordingly, the user may intuitively recognize that the sentence 1-1 811 and the sentence 1-2 812 are the related texts for the sentence 1 810.

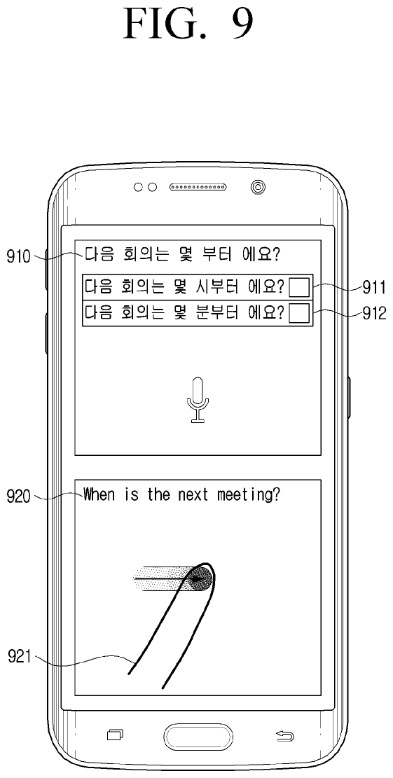

FIG. 9 is an illustrative diagram for describing a method of receiving text through voice recognition according to another embodiment of the disclosure.

Specifically, as illustrated in FIG. 9, if a function of receiving a text through voice recognition is executed, the electronic device 100 may display a microphone-shaped icon on the bottom of a first UI 910. The electronic device 100 may analyze the input user voice and display a text corresponding to the input voice on the first UI 910.

In this case, even if the user speaks “ [symbol] [symbol] [symbol] ?”, a text “ [symbol] [symbol] ?” may be output because voice recognition is incorrect. Therefore, the electronic device 100 may determine whether the text corresponding to the input voice is a voice recognition error, or may determine whether the text is incorrect text. If the voice recognition is an error or incorrect text, the electronic device 100 may provide alternative sentences 911 and 912 of the input text and display the same on the first UI. That is, when “ [symbol] [symbol] ?” is input, the electronic device 100 may determine that the input text is the voice recognition error or the incorrect text, and may acquire alternative text such as “ [symbol] [symbol] ?” or “ [symbol] [symbol] ?” and display the same on the first UI 910.

Meanwhile, when the electronic device 100 is a small screen display device such as a smartphone, it may be difficult for the electronic device 100 to display all of the input text, the translation in which the input text is translated, one or more related texts for the input text, and one or more translations for one or more related texts. That is, when the electronic device 100 displays all of the input text, the translation in which the input text is translated, one or more related texts for the input text, and one or more translations for one or more related texts, there is a problem that the font size is too small.

Therefore, when the electronic device 100 is the small screen display device, as illustrated in FIG. 9, the input text may be displayed on the first UI 910 and only the translation for the input text may be displayed on the second UI 920. In this case, if a predetermined user command is input, the electronic device 100 may display related texts for the input text or the translation in which the input text is translated.

For example, when the predetermined user command is a touch and drag command 921 and the touch and drag command 921 is performed on the second UI 920, the electronic device 100 may delete “When is the next meeting” that was displayed on the second UI 920 and may display related texts such as “When time is the next meeting from?”, “Has the date of the next meeting been fixed?”, and the like. In this case, if the text displayed on the second UI 920 is changed, the electronic device 100 may change the text displayed on the first UI 910 to correspond to the text displayed on the second UI 920.

On the other hand, the above-described embodiment describes that the predetermined user command is input to the second UI 920, but even when the predetermined user command is input to the first UI 910, the related texts may be displayed by the same method.

In addition, the above-described embodiment describes that when the text of any one of the first UI 910 and the second UI 920 is changed by the predetermined user command, the text displayed on the other UI is also changed, but the disclosure is not limited thereto. That is, when the predetermined user command is input to the second UI 920, only the text displayed on the second UI 920 may be changed and the text displayed on the first UI 910 may not be changed.

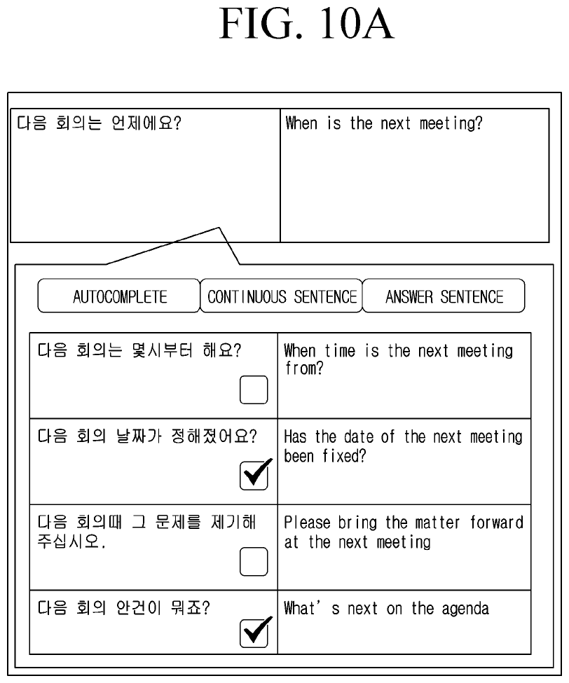

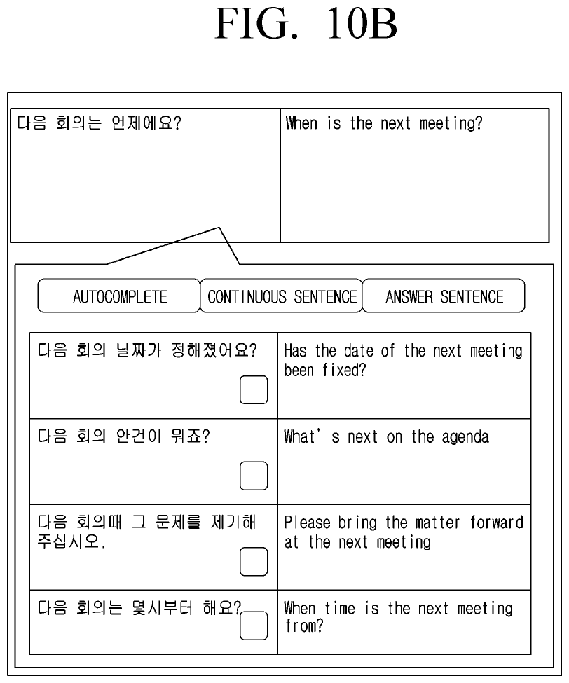

FIGS. 10A and 10B are illustrative diagrams for describing a method of aligning related texts according to an embodiment of the disclosure.

Specifically, as illustrated in FIG. 10A, when a text “ [symbol] [symbol] ?” is input, the electronic device 100 may align and display the related texts in the order of “ [symbol] ?”, “ [symbol] [symbol] ?”, “ [symbol] [symbol] [symbol] .”, and “ [symbol] [symbol] ?”.

In this case, when the text “ [symbol] [symbol] ?” is input to the first UI and an operation in which the related texts are displayed on the first UI according to the user command of selecting the related texts thereof occurs a plurality of times, the electronic device 100 may acquire a matching table using information on the selected related text for the input text.

TABLE 1

| Input | One or More | Number of Times |
|---|---|---|
| Text | Related Texts | of Selection |
| [symbol] | [symbol] [symbol] | 1 |
| [symbol] | [symbol] | |
| | [symbol] | 7 |
| | [symbol] ? | |
| | [symbol] [symbol] | 3 |
| | [symbol] . | |
| | [symbol] ? | 5 |

That is, referring to Table 1, when the operation in which the text “ [symbol] ” is input occurs a plurality of times, and for each operation, “ [symbol] [symbol] ?” is selected once, “ [symbol] [symbol] [symbol] ?” is selected seven times, “ [symbol] [symbol] [symbol] ” is selected three times, and “ [symbol] [symbol] ?” is selected five times, the electronic device 100 may store a related text selection result in the matching table. Thereafter, when the operation in which the text “ [symbol] ?” is input occurs again, the electronic device 100 may align and display the related text based on the number of times the related text is selected. Specifically, as illustrated in FIG. 10B, the electronic device 100 may first align and display the most selected “ [symbol] [symbol] ?”, and may finally align and display the least selected “ [symbol] [symbol] ?”.

On the other hand, in the above-described embodiment, the method of the electronic device 100 acquiring the matching table for the same related text for the same text has been described, but the disclosure is not limited thereto. That is, the electronic device 100 may acquire a matching table for text having the same or similar context by identifying the context of the input text and the related texts.

For example, the electronic device 100 may acquire one match table for the text having the same context such as “ [symbol] [symbol] ?”, “ [symbol] [symbol] ?”, and “ [symbol] [symbol] ?”.

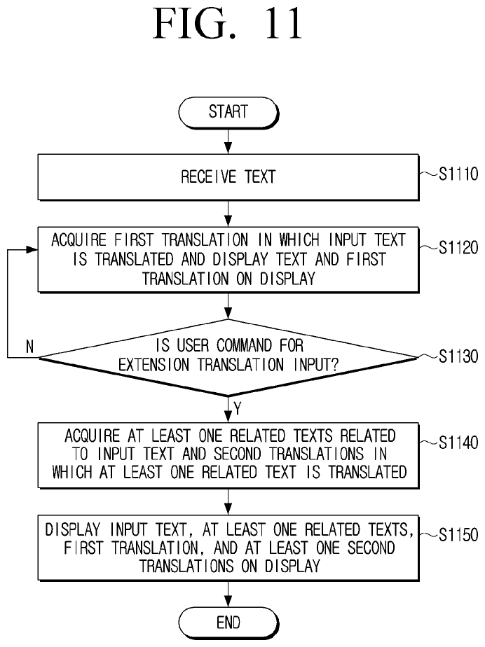

FIG. 11 is a flowchart for describing a control method of an electronic device according to an embodiment of the disclosure.

First, the electronic device 100 may receive a text according to a user command (S1110). In this case, the user command may be generated by various input devices such as a microphone, a touch panel, and a keyboard.

If the text is input, the electronic device 100 may acquire a first translation in which the input text is translated, and may display the text and the first translation on the display (S1120). Specifically, the electronic device 100 may display the input text and the first translation on the first UI. In addition, as described above, the electronic device may automatically display the first translation on the first UI, but may also display the first translation when a user command for translation is input.

Thereafter, the electronic device 100 may receive a user command for extension translation (S1130). If the user command for extension translation is not received (N in S1130), the electronic device 100 maintains the state of S1120.

If the user command for extension translation is received (Y in S1130), the electronic device 100 may acquire one or more related texts related to the input text and second translations in which one or more related texts are translated (S1140). However, as described above, the electronic device 100 may acquire related texts for the first translation, not the input text.

Thereafter, the electronic device 100 may display the input text, one or more related texts, the first translation, and one or more second translations on the display (S1150).

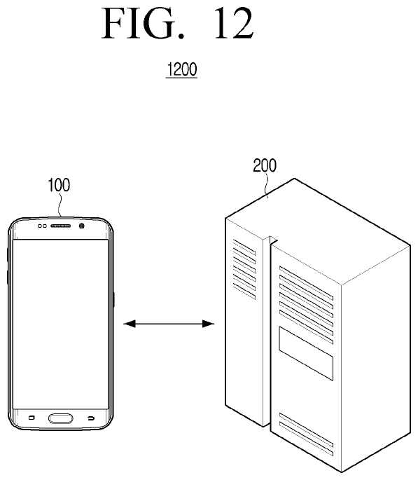

FIG. 12 is an illustrative diagram for describing a system according to an embodiment of the disclosure. As illustrated in FIG. 12, the system 1200 may include an electronic device 100 and an external server 200.

Specifically, in the above-described embodiment, it has been described that all the operations are performed in the electronic device 100, but a part of the operations of the electronic device 100 may be performed in the external server 200. For example, the electronic device 100 may generate the translation in which the text is translated, and the external server 200 may acquire the related texts for the text.

In this case, according to an embodiment of the disclosure, the processor 130 of the electronic device 100 may be implemented as a general purpose processor, and a processor of the external server 200 may be implemented as an artificial intelligence dedicated processor. A detailed operation of the electronic device 100 and the external server 200 will be described below.

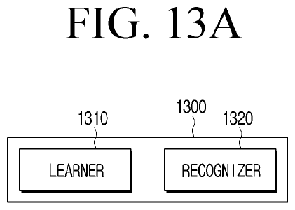

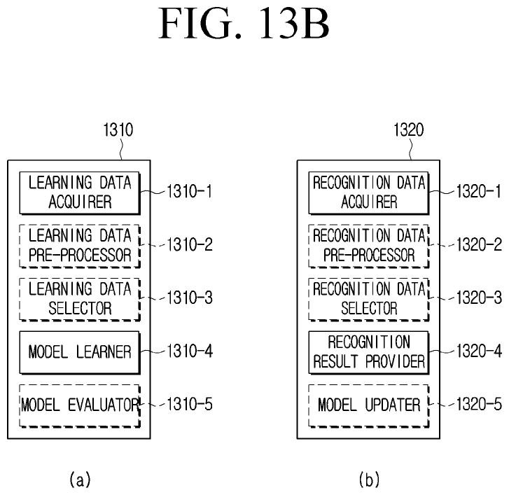

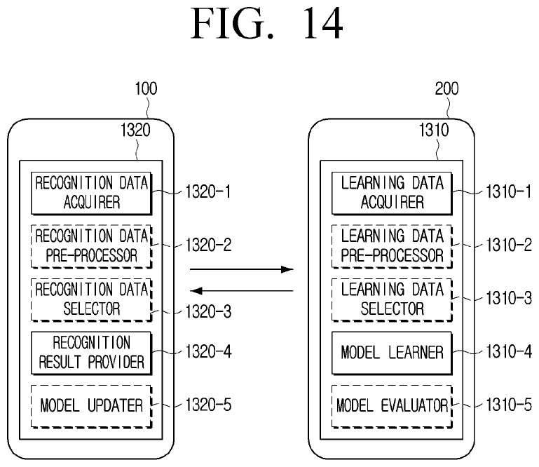

Hereinafter, a method of generating a recognition model using a learning algorithm and then acquiring related texts through the generated recognition model according to an embodiment of the disclosure will be described with reference to FIGS. 13A to 14.

FIGS. 13A and 13B are block diagrams illustrating a learner and a recognizer according to diverse embodiments.

Referring to FIG. 13A, a processor 1300 may include at least one of a learner 1310 or a recognizer 1320. The processor 1300 of FIG. 13A may correspond to the process of the electronic device 100 or the external server 200.

The learner 1310 may generate or learn a recognition model having a criterion for a predetermined situation determination. The learner 1310 may generate the recognition model having a determination criterion using collected learning data.

As an example, the learner 1310 may generate, learn, or update the recognition model having a criterion for determining the context for the text by using the text received by the electronic device 100 as the learning data.

As another example, the learner 1310 may generate, learn, or update the recognition model having a criterion for determining the context of the translations in which the text and the related texts are translated by using the text received by the electronic device 100 and the related texts for the text as the learning data.

The recognizer 1320 may estimate a recognition target included in predetermined data by using the predetermined data as input data of the learned recognition model.

As an example, the recognizer 1320 may obtain (or estimate and deduce) information on the related texts by using the text received by the electronic device 100 as the input data of the learned recognition model.

As another example, the recognizer 1320 may obtain (or estimate and deduce) information on the translations in which the received text and the related texts are translated by using the text received by the electronic device 100 and the related texts as the input data of the learned recognition model.

At least a portion of the learner 1310 and at least a portion of the recognizer 1320 may be implemented as a software module or manufactured in the form of at least one hardware chip to be mounted in the electronic device. For example, at least one of the learner 1310 or the recognizer 1320 may also be manufactured in the form of a dedicated hardware chip for artificial intelligence (AI), or may be manufactured as a portion of an existing general purpose processor (e.g., CPU or application processor) or a graphics dedicated processor (e.g., GPU) to be mounted in a variety of electronic devices described above. In this case, the dedicated hardware chip for artificial intelligence is a dedicated processor specialized for a probability calculation, and has higher parallel processing performance than the conventional general purpose processor, so it may quickly process calculation operations in an artificial intelligence field such as machine learning. When the learner 1310 and the recognizer 1320 are implemented as a software module (or a program module including instructions), the software module may be stored in a non-transitory computer readable media. In this case, the software module may be provided by an operating system (OS), or may be provided by a predetermined application. Alternatively, a portion of the software module may be provided by the operating system (OS), and the remaining of the software module may be provided by the predetermined application.

In this case, the learner 1310 and the recognizer 1320 may also be mounted in one electronic device, or may also be mounted in separate electronic devices, respectively. For example, one of the learner 1310 and the recognizer 1320 may be included in the electronic device 100, and the other may be included in the external server 200. In addition, the learner 1310 and the recognizer 1320 may also provide model information constructed by the learner 1310 to the recognizer 1320 by a wired or wireless manner, and the data input to the learner 1320 may also be provided to the learner 1310 as additional learning data.

FIG. 13B is a block diagram of the learner 1310 and the recognizer 1320 according to diverse embodiments.

Referring to FIG. 13B, the learner 1310 according to some embodiments may include a learning data acquirer 1310-1 and a model learner 1310-4. In addition, the learner 1310 may selectively further include at least one of a learning data pre-processor 1310-2, a learning data selector 1310-3, or a model evaluator 1310-5.

The learning data acquirer 1310-1 may acquire learning data necessary for a recognition model for deducing a recognition target. As an example, the learning data acquirer 1310-1 may acquire texts for various languages as learning data.

The model learner 1310-4 may learn the recognition model so as to have a determination criterion regarding how the recognition model determines a predetermined recognition target by using the learning data. For example, the model learner 1310-4 may learn the recognition model through supervised learning using at least a portion of the learning data as the determination criterion. Alternatively, the model learner 1310-4 may learn the recognition model through unsupervised learning of finding the determination criterion for determining a situation by performing self-learning using the learning data without any supervision, for example. In addition, the model learner 1210-4 may learn the recognition model through reinforcement learning using a feedback as to whether a result of the situation determination according to the learning is correct, for example. In addition, the model learner 1310-4 may learn the recognition model by using a learning algorithm or the like including, for example, error back-propagation or gradient descent.

In addition, the model learner 1310-4 may also learn a selection criterion about which learning data should be used to estimate the recognition target using the input data.

When there are a plurality of pre-constructed recognition models, the model learner 1310-4 may determine a recognition model having a great relationship between the input learning data and basic learning data as a recognition model to be learned. In this case, the basic learning data may be pre-classified for each type of data, and the recognition model may be pre-constructed for each type of data. For example, the basic learning data may be pre-classified by various criteria such as an area in which the learning data is generated, a time at which the learning data is generated, a size of the learning data, a genre of the learning data, a generator of the learning data, types of objects in the learning data, and the like.

When the recognition model is learned, the model learner 1310-4 may store the learned recognition model. In this case, the model learner 1310-4 may store the learned recognition model in the memory 140 of the electronic device 100. Alternatively, the model learner 1310-4 may store the learned recognition model in the memory of the server connected to the electronic device 100 via a wired or wireless network.

The learner 1310 may further include the learning data pre-processor 1310-2 and the learning data selector 1310-3 to improve an analysis result of the recognition model or to save resources or time required for generation of the recognition model.

The learning data pre-processor 1310-2 may pre-process the acquired data so that the acquired data may be used for learning for the situation determination. The learning data pre-processor 1310-2 may process the acquired data into a predetermined format so that the model learner 1310-4 may use the acquired data for the learning for the situation determination.

The learning data selector 1310-3 may select data necessary for learning from the data acquired by the learning data acquirer 1310-1 or the data pre-processed by the learning data pre-processor 1310-2. The selected learning data may be provided to the model learner 1310-4. The learning data selector 1310-3 may select learning data necessary for learning among the acquired or pre-processed data, depending on a predetermined selection criterion. In addition, the learning data selector 1310-3 may also select the learning data according to a predetermined selection criterion by learning by the model learner 1310-4.

The learner 1310 may further include the model evaluator 1310-5 to improve the analysis result of the data recognition model.

The model evaluator 1310-5 may input evaluation data to the recognition model, and may cause the model learner 1310-4 to learn again when the analysis result outputted from the evaluation data does not satisfy a predetermined criterion. In this case, the evaluation data may be predefined data for evaluating the recognition model.

For example, when the number or ratio of the evaluation data in which the analysis result is not correct among the analysis results of the learned recognition model for the evaluation data exceeds a predetermined threshold value, the model evaluator 1210-5 may evaluate that the predetermined criterion is not satisfied.

Meanwhile, when a plurality of learned recognition models exist, the model evaluator 1310-5 may evaluate whether each of the learned recognition models satisfies the predetermined criterion, and determine a model satisfying the predetermined criterion as a final recognition model. In this case, when there are a plurality of models satisfying the predetermined criterion, the model evaluator 1310-5 may determine any one or a predetermined number of models previously set in descending order of evaluation score as the final recognition model.

Referring back to FIG. 13B, the data analyzer 1320 according to some embodiments may include a recognition data acquirer 1320-1 and a recognition data provider 1320-4.

In addition, the data analyzer 1320 may selectively further include at least one of a recognition data pre-processor 1320-2, a recognition data selector 1320-3, or a model updater 1320-5.

The recognition data acquirer 1320-1 may acquire data necessary for a situation determination. The recognition result provider 1320-4 may determine a situation by applying the data acquired by the recognition data acquirer 1320-1 to the learned recognition model as an input value. The recognition result provider 1320-4 may provide an analysis result according to an analysis purpose of the data. The recognition result provider 1320-4 may acquire the analysis result by applying the data selected by the recognition data pre-processor 1320-2 or the recognition data selector 1320-3 to be described later to the recognition model as an input value. The analysis result may be determined by the recognition model.

As an example, the recognition result provider 1320-4 may acquire (or estimate) information on the related texts by applying the text acquired by the recognition data acquirer 1320-1 to the learned recognition model.

As another example, the recognition result provider 1320-4 may acquire (or estimate) the translations for the text and the related texts by applying the text acquired by the recognition data acquirer 1320-1 and the related texts to the learned recognition model.

The data analyzer 1320 may further include the recognition data pre-processor 1320-2 and the recognition data selector 1320-3 to improve the analysis result of the recognition model or to save resources or time for provision of the analysis result.

The recognition data pre-processor 1320-2 may pre-process the acquired data so that the acquired data may be used for the situation determination. The recognition data pre-processor 1320-2 may process the acquired data into a predetermined format so that the recognition result provider 1320-4 may use the acquired data for the situation determination.

The recognition data selector 1320-3 may select data necessary for situation determination among the data acquired by the recognition data acquirer 1320-1 or the data pre-processed by the recognition data pre-processor 1320-2. The selected data may be provided to the recognition result provider 1320-4. The recognition data selector 1320-3 may select some or all of the acquired or pre-processed data, depending on a predetermined selection criterion for the situation determination. In addition, the recognition data selector 1320-3 may also select the data according to a predetermined selection criterion by learning by the model learner 1310-4.

The model updater 1320-5 may control the recognition model to be updated based on the evaluation for the analysis result provided by the recognition result provider 1320-4. For example, the model updater 1320-5 may request the model learner 1310-4 to additionally learn or update the recognition model by providing the analysis result provided by the recognition result provider 1310-4 to the model learner 1310-4.

FIG. 14 is a diagram illustrating an example in which an electronic device 100 and a server 200 interlock with each other to learn and recognize data according to an embodiment of the disclosure.

Referring to FIG. 14, the server 200 may learn a criterion for situation determination, and the electronic device 100 may determine a situation based on a learning result by the server 200.

In this case, the model learner 1310-4 of the server 200 may perform the function of the learner 1310 illustrated in FIG. 13A. The model learner 1310-4 may learn a criterion for situation determination by acquiring data to be used for learning and applying the acquired data to the recognition model.

In addition, the recognition result provider 1320-4 of the electronic device 100 may determine the related texts or the translations for the text and the related texts by applying the data selected by the recognition data selector 1320-3 to the recognition model generated by the server 200. Alternatively, the recognition result provider 1320-4 of the electronic device 100 may receive the recognition model generated by the server 200 from the server 200, and may determine the situation using the received recognition model.

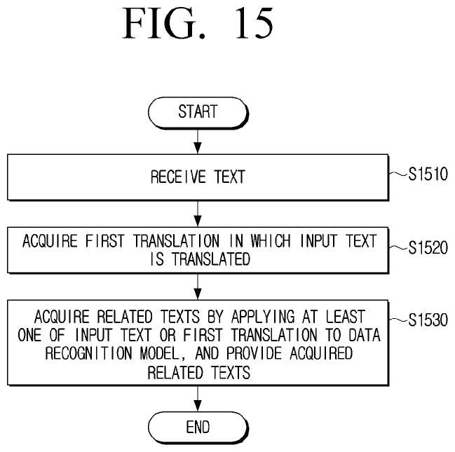

FIG. 15 is a flowchart of the electronic device using a recognition model according to an embodiment of the disclosure. However, as described above, the electronic device 100 may also be implemented as the external server 200.

First, the electronic device 100 may receive a text corresponding to a user command (S1510). The electronic device 100 may acquire a first translation by translating the input text (S1520). The electronic device 100 may acquire related texts for the input text by applying at least one of the input text or the first translation to the recognition model, and provide the acquired related texts (S1530).

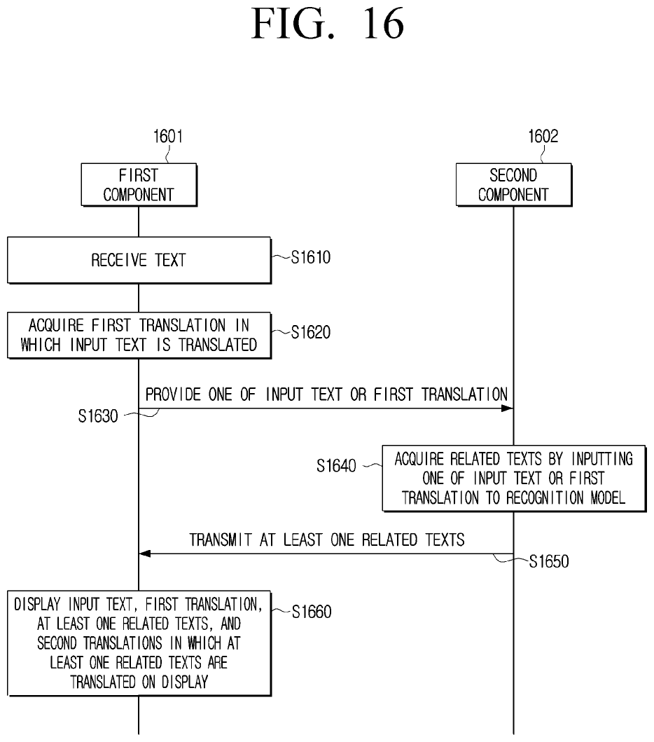

FIG. 16 is a flowchart of a network system using a recognition model according to an embodiment of the disclosure. The network system may include a first component 1601 and a second component 1602. In this case, the first component 1601 may be the electronic device 100, and the second component 1602 may be the external server 200 in which the recognition model is stored. Alternatively, the first component 1601 may be a general purpose processor and the second component 1602 may be an artificial intelligence dedicated processor. Alternatively, the first component 1601 may be at least one application and the second component 1602 may be an operating system (OS). The second component 1602 is a component that is more integrated, dedicated, has less delay, has excellent performance, or has more resources than the first component 1601, and may be a component capable of processing many calculations that are required at the time of generating, updating, or applying the recognition model faster and more efficiently than the first component 1601.

In this case, an interface for transmitting/receiving data between the first component 1601 and the second component 1602 may be defined.

As an example, an application program interface (API) having learning data to be applied to the recognition model as an argument value (or an intermediate value or a transfer value) may be defined. The API may be defined as a set of subroutines or functions that may be called for any processing of another protocol (e.g., a protocol defined in the server 200) in any one protocol (e.g., a protocol defined in the electronic device 100). That is, an environment in which an operation of another protocol may be performed in any one protocol through the API may be provided.

Referring back to FIG. 16, the first component 1601 may receive a text (S1610) and acquire a first text in which the input text is translated (S1620).

Next, the first component 1601 may transmit at least one of the input text or the first translation to the second component 1602 (S1630).

The second component 1602 may acquire one or more related texts by inputting at least one of the received text or the first translation to the recognition model (S1640), and transmit one or more acquired related texts to the first component 1601 (S1650).

The first component 1601 may display the input text, the first translation, one or more related texts, and second translations in which one or more related texts are translated on the display (S1660).

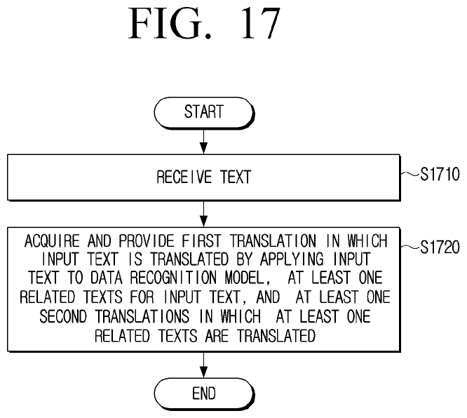

FIG. 17 is a flowchart of an electronic device using a recognition model according to another embodiment of the disclosure.

The electronic device 100 may receive a text (S1710), and acquire a first translation in which the input text is translated by applying the input text to the recognition model, one or more related texts for the input text, and one or more second translations in which one or more related texts are translated (S1720).

That is, in FIG. 15, the electronic device 100 acquires information on the related texts using the recognition model, but in FIG. 17, the electronic device 100 may acquire the related texts and the translations thereof using the recognition model.

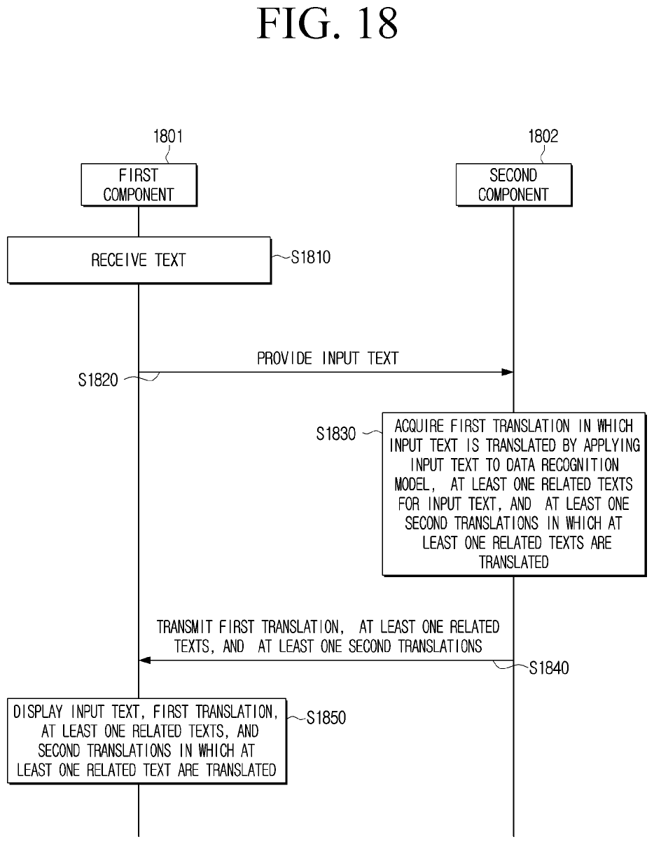

FIG. 18 is a flowchart of a network system using a recognition model according to an embodiment of the disclosure. A detailed description thereof is the same as that described with reference to FIG. 16.

First, a first component 1801 may receive a text (S1810). The first component 1801 may transmit the input text to a second component 1802 (S1820).

The second component 1802 may acquire a first translation in which the input text is translated by applying the input text to the recognition model, one or more related texts for the input text, and one or more second translations in which one or more related texts are translated (S1830).

The second component 1802 may transmit the first translation, one or more related texts, and one or more second translations to the first component 1801 (S1840), and the first component 1801 may display the input text, the first translation, one or more related texts, and the second translations in which one or more related texts are translated on the display.

The disclosed embodiments may be implemented by software programs including instructions that are stored in machine-readable storage media.

For example, the computer may include an X-ray apparatus or an external server communicatively connected to the X-ray apparatus according to the disclosed embodiments, as an apparatus that invokes the stored instructions from the storage medium and is operable according to the disclosed embodiments according to the invoked instruction.

The machine-readable storage media may be provided in the form of non-transitory storage media. Here, the term ‘non-transitory’ means that the storage medium does not include a signal and a current and is tangible, but does not distinguish whether data is stored semi-permanently or temporarily in the storage medium. For example, the non-transitory storage media may include not only a non-transitory readable medium such as a CD, a digital versatile disk (DVD), a hard disk, a Blu-ray disk, a USB, an internal memory, a memory card, ROM, RAM, or the like, but also a medium that is temporarily stored such as a register, a cache, or a buffer.

In addition, the method according to the disclosed embodiments may be provided as a computer program product.

The computer program product may include a S/W program, a computer readable storage medium on which the S/W program is stored, or a product traded between a seller and a buyer.

For example, the computer program product may include a product (e.g., a downloadable application) in the form of an S/W program that is distributed electronically through a manufacturer of an X-ray apparatus or an electronic market (e.g., Google Play Store, App Store). For electronic distribution, at least a part of the S/W program may be stored in a storage medium or temporarily generated. In this case, the storage medium may be a storage medium of a server of the manufacturer or the electronic market, or a relay server.

Although the embodiments of the disclosure have been illustrated and described above, the disclosure is not limited to the above-described specific embodiments and may be variously modified by those skilled in the art without departing from the gist of the disclosure as claimed in the claims, and such modifications should not be individually understood from the technical spirit or the prospect of the present disclosure.

1. An electronic device comprising:
an inputter;
a display; and
a processor configured to:
acquire a first translation in which an input text is translated based on a text being inputted through the inputter, and control the display to display the input text and the first translation,
acquire at least one related text related to the input text and second translations in which at least one related text is translated, based on a predetermined user command being inputted, and
control the display to display the input text, the first translation, at least one related text, at least one second translation.

2. The electronic device as claimed in claim 1, wherein the processor is configured to control the display to:
display the input text and the first translation on a first user interface (UI), and
display at least one related text and at least one second translation on a second UI displayed separately from the first UI.

3. The electronic device as claimed in claim 2, wherein the processor is configured to control the display to add and display a selected text and a translation corresponding to the selected text to the first UI, based on a user command of selecting one of at least one related text displayed on the second UI being inputted.

4. The electronic device as claimed in claim 1, wherein at least one related text is one of an answer text for the input text, a text that is contextually connected to the input text, or a text that supplements the input text.

5. The electronic device as claimed in claim 1, further comprising a memory,
wherein the processor is configured to:
generate a matching table by matching the input text with a selected text based on one of at least one related text being selected, and
store the matching table in the memory.

6. The electronic device as claimed in claim 5, wherein the processor is configured to control the display to align and display at least one text related to the input text based on the input text and the matching table, in response to the text being inputted through the inputter.

7. The electronic device as claimed in claim 1, wherein the predetermined user command is a drag command that touches and drags one of an area on which the input text is displayed or an area on which the first translation is displayed, and
the processor is configured to:
acquire at least one related text and at least one second translation that is acquired based on the text, based on the drag command being inputted to the area on which the text is displayed, and
acquire at least one related text and at least one second translation that is acquired based on the first translation, in response to the drag command being inputted to the area on which the first translation is displayed.

8. The electronic device as claimed in claim 1, wherein the inputter includes a microphone, and
the processor is configured to:
acquire a text corresponding to an input voice, based on voice recognition being inputted through the microphone, and
acquire an alternative text based on the acquired text, in response to the acquired text being an incomplete sentence.

9. A control method of an electronic device, the control method comprising:
acquiring a first translation in which an input text is translated based on a text being inputted, and displaying the input text and the first translation;
acquiring at least one related text related to the input text and second translations in which at least one related text is translated, based on a predetermined user command being inputted; and
displaying the input text, the first translation, at least one related text, and at least one second translation.

10. The control method as claimed in claim 9, wherein in the displaying, the input text and the first translation are displayed on a first user interface (UI), and at least one related text and at least one second translation is displayed on a second UI displayed separately from the first UI.

11. The control method as claimed in claim 10, wherein the displaying further includes adding and displaying a selected text and a translation corresponding to the selected text to the first UI, based on a user command of selecting one of at least one related text displayed on the second UI being inputted.

12. The control method as claimed in claim 9, wherein at least one text is one of an answer text for the input text, a text that is contextually connected to the input text, or a text that supplements the input text.

13. The control method as claimed in claim 9, further comprising generating a matching table by matching the input text with a selected text based on one of at least one related text being selected, and storing the matching table.

14. The control method as claimed in claim 13, wherein the displaying further includes aligning and displaying at least one text related to the input text based on the input text and the matching table, in response to the text being inputted.

15. The control method as claimed in claim 9, wherein the predetermined user command is a drag command that touches and drags one of an area on which the input text is displayed or an area on which the first translation is displayed, and
in the acquiring of the second translations, at least one related text and at least one second translation that is acquired based on the text are acquired, in response to the drag command being inputted to the area on which the text is displayed, and
at least one related texts and at least one second translation that is acquired based on the first translation are acquired, in response to the drag command being inputted to the area on which the first translation is displayed.
